(19) United States
(12) Patent Application Publication
(10) Pub. No.: US 2014/0287169 A1
(43) Pub. Date: Sep. 25, 2014

(54) ARTIFICIAL TURF BARRIER WITH ARTIFICIAL TURF EDGE

(71) Applicants: Heribert GUENTNER, Egenhofen (DE); Anton HUBER, Fuerstenfeldbruck (DE)

(72) Inventors: Heribert GUENTNER, Egenhofen (DE); Anton HUBER, Fuerstenfeldbruck (DE)

(21) Appl. No.: 14/217,966

(22) Filed: Mar. 18, 2014

(30) Foreign Application Priority Data
Mar. 20, 2013 (DE) 20 2013 002 685.5
Feb. 17, 2014 (EP) 14 155 446.9

(51) Int. Cl. E01C 13/08; B29C 45/14

(52) U.S. Cl. CPC E01C 13/08; B29C 45/14467
USPC 428/17; 264/279

(57) ABSTRACT

An artificial turf barrier including a lawn barrier, an artificial turf, and a connecting area for the artificial turf. A connecting grid is also provided. A method for manufacturing an artificial turf barrier including a lawn barrier and a connecting grid, the lawn barrier and the connecting grid being formed by injection molding. An artificial turf portion cut to size is inserted into an injection mold and the lawn barrier and the connecting grid are non-detachably combined with the artificial turf portion during injection molding.

### FIELD OF THE INVENTION

The invention relates to an artificial turf barrier including a lawn barrier, artificial turf and a connecting area for the artificial turf. The invention also relates to a method for producing such an artificial turf barrier including a lawn barrier and a connecting grid, the lawn barrier and the connecting grid being formed by injection molding.

### BACKGROUND OF THE INVENTION

Artificial turf limitations or borders are known, e.g. from DE 88 16 399 U1 which discloses an element for limiting lawn areas. Said element includes a high wedge-shaped portion which is to be forced into the soil. The wider side of this wedge-shaped portion is provided with a plate to which an artificial lawn attachment has been applied. The disclosed element is disadvantageous in that said plate is described to be several centimeters thick and rest on the soil. For lawn areas of low grass height, for instance golf courses where the grass is partially just a few millimeters tall, the bordering element disclosed in the DE 88 16 399 U1 is not suitable as it is hindering when mowing the lawn and is, besides, a tripping hazard or stumbling block. U.S. Pat. No. 3,916,563 A discloses a lawn edge substantially consisting of a plate and a grid. It is the intention to completely bury the plate vertically in the soil. The grid is mounted to said plate such that it extends horizontally from the plate towards the lawn, lines up precisely with the upper edge of the plate and is, thus, also completely buried in the soil. Accordingly, lawn mowers can be moved over said grid. This solution is disadvantageous in that the relatively narrow plate which is, moreover, entirely buried in the soil can easily be overgrown with blades of grass. Hence follows that unwanted spreading of grass beyond the plate, for instance due to layers or falling seeds, cannot be prevented effectively.

U.S. Pat. No. 5,544,445 A discloses a landscape edging device. As in case of the limiting element according to DE 88 16 399 U1, said device is not to be entirely buried in the soil. The danger of stumbling is here to be reduced in that a part of the structures extending above the surface is designed in a flexible manner so that these flexible structures are pressed down when being stepped on or rolled over, e.g. by a lawn mower. However, said device has the same disadvantages as the element disclosed in the DE 88 16 399 U1, even if possibly to a minor degree.

### SUMMARY OF THE INVENTION

Apart from the above-described disadvantages, certain lawn limitations imply further problems which are not even mentioned in the above-cited documents. In irrigation systems, water is dispersed over a specified area. To this end, a nozzle is moved upward so that water can be sprayed over an area. However, when the nozzle is overgrown with grass said grass or similar weeds obstruct the system so that the water cannot be distributed evenly. Consequently, some areas will no longer be irrigated and other areas will be flooded.

Nozzles overgrown with grass or the like also entail great risks of accident. Any person who does not recognize the danger might roll his/her ankle which may cause ankle injuries. At present, the problem arising with golf course irrigation systems when overgrown with grass is solved with the help of additional staff. In case of paths, beds and areas bordering meadows, the grass will eventually overgrow the paved zone or the zone that should be kept free. To keep a bed well-tended, it has to be weeded every 2-3 weeks.

Accordingly, it is an object of the invention to provide an artificial turf barrier which, by the provision of structural measures that are as simple as possible, can be used to limit or border particularly close-cropped lawn areas, to ease mowing of these lawn areas and to prevent as effectively as possible overgrowing of the barrier, yet without increasing the risk of stumbling.

According to the invention, this object is solved by an artificial turf barrier including a lawn barrier, artificial turf and a connecting area for the artificial turf, wherein the artificial turf barrier includes a connecting grid and by an artificial turf barrier which is manufactured by cutting to size an artificial turf portion, inserting the artificial turf portion into an injection mold, and non-detachably combining the lawn barrier and the connecting grid with the artificial turf portion during injection molding.

The artificial turf barrier according to the invention includes a lawn barrier, artificial turf, and a connecting area for the artificial turf. It is characterized in that a connecting grid is additionally provided. For instance, the artificial turf border can be characterized in that it comprises artificial turf, a lawn barrier, a connecting grid, and a connecting area for the artificial turf. In the following, the terms lawn barrier and growth barrier will be used synonymously. In case of the artificial turf border according to the invention, the artificial turf provided is preferably a barrier against overgrowing which will remain effective even if the artificial turf barrier has entirely been inserted to soil level. No blades of grass of the adjacent natural lawn will be able to grow through the dense artificial turf.

Owing to the flexibility of the blades of the artificial turf and to the fact that these do not grow, the barrier formed by the artificial turf poses neither an obstacle with regard to mowing nor a risk of stumbling.

It is advantageous to have an artificial turf barrier with a round lawn barrier which projects preferably about 5 to 10 cm, e.g. about 8 cm, deep into the soil and, thus, also serves as a stabilizing element. To this, the artificial turf border can, e.g. be characterized in that it consists of a round growth barrier which projects about 5 to 10 cm, e.g. about 8 cm, deep into the soil and, thus, may also serve as a stabilizing element. In case of normal lawn areas, such depth of penetration can prevent the roots of the natural lawn area from growing into the area separated by the artificial turf barrier.

It is particularly favorable when the artificial turf barrier has a round or circularly-shaped cut-out provided in the center of the lawn barrier in order to allow an irrigation system nozzle to distribute water properly. The circular cut-out may have a diameter of, e.g. 8 to 15 cm, e.g. 12 cm. Due to the artificial turf barrier, growth of plants in an area too close to the irrigating nozzles can thus be prevented, among other things. Besides, it continuously provides for a more cultivated appearance over. In Addition, it also provides the following advantages:
More accurate and reliable irrigation.
Staff reduction for pruning, cleaning and maintaining.
Preventing any errors that might arise when the irrigation system is cleaned by staff.
Significant time savings for garden maintenance.
Prevention of accidents.

In another advantageous embodiment, the artificial turf barrier is closed in the center of the lawn barrier. Accordingly, it can be used, for example, to cover structures integrated into the ground, e.g. switchboxes or fastening elements for posts or the like. Such an artificial turf barrier can either be formed integrally and/or permanently closed. However, removable or opening elements, e.g. lids or flaps, may also be provided.

It is advisable to provide the connecting area between an edge of the connecting grid and the cut-out. In this way the barrier effect of the artificial turf laid onto the connecting area is most effective. For example, the edge of the connecting grid may have an area to the cut-out of a diameter of about 12 cm which is a bonding area.

In an advantageous embodiment, the connecting area of the artificial turf barrier may have an outer diameter of e.g. 25 to 30 cm. The bonding area, preferably of a diameter between 25 and 30 cm, may be applied to the connecting grid 2 to 3 cm underneath the artificial turf bonding area.

It is advantageous to apply the connecting grid 2 to 3 cm underneath the connecting area. Such a configuration may be advantageous if the grid is to be buried deeper into the soil. When new lawn is laid, such limiting elements for artificial turf can be positioned in advance. Then, sod lawn, for instance, can be laid onto the connecting grid, thus making the integration of the artificial turf barrier into the lawn area especially stable.

Advantageously, the connecting grid projects laterally about 4 to 5 cm from the artificial turf to be applied, thus providing a sufficient area into which the natural lawn can grow.

It is conceivable that the applied artificial turf, provided at the connecting area between the cut-out and the connecting grid, is connected to the connecting area by back injection molding. This enables a simple and fast manufacture and provides for a robust and durable connection.

According to an advantageous embodiment, the artificial turf barrier includes a straight lawn barrier, preferably projecting about 5 to 10 cm, e.g. about 8 cm, deep into the soil. In the following, such straight artificial turf barriers are sometimes also called artificial turf edges. In principle, the terms artificial turf edge and artificial turf barrier can be used synonymously. An artificial turf edge can, for example, be characterized in that it consists of artificial turf, a lawn barrier, a connecting grid, and a connecting area for the artificial turf. Straight artificial turf barriers are advantageous for edging straight portions, e.g. paths or beds.

Also conceivable are angled artificial turf edges, corner pieces and artificial turf edges of a radius so that arched borders of a bed can also be edged.

The artificial turf edge may preferably have an total length of 34 cm. Providing individual artificial turf barriers of this length enables a flexible definition of lawn edge contours.

It may be advantageous to provide a concave radius on one end of the artificial turf barrier and a convex radius on the other end. In particular, straight artificial turf barriers can thus be laid in a flexible manner, e. g. at an angle with regard to each other, without getting irregular gaps.

It may be advantageous to provide a hook on one end of the artificial turf barrier for combining individual elements with each other seamlessly. Here, individual elements have to be understood as neighboring artificial turf barriers.

It may be advantageously to have the lawn barrier extending over the entire component. Thus, growth of natural lawn and other unwanted plants into the area isolated from the lawn area is inhibited over the entire length of the artificial turf edge.

It may be advantageous to have a stabilizing bar extending parallel to the lawn barrier at a distance of about 5 cm and projecting about 8 cm deep into the soil. On the one hand, this may improve stability against twisting of the artificial turf barrier. On the other hand, it may also improve the barrier effect underground.

According to an advantageous embodiment, a natural bottom side can be provided on the connecting grid intended to grow together with the natural lawn. This may enhance stability.

In a straight artificial turf barrier it may be advantageous to have a connecting grid having a width of about 4 to 5 cm and extending over the entire length of the artificial turf barrier. Thus, an area of sufficient size can be provided which can grow together with the natural lawn.

According to an embodiment of the invention, the artificial turf can be applied at a width of about 7 cm to the component over the entire length thereof by back injection molding. Straight artificial turf barriers can also be manufactured in this way easily and quickly, simultaneously providing for a robust and durable connection.

It may be advantageous for the artificial turf barrier to be made of thermoplastic synthetic resin or other suitable plastics or polymers. This may be advantageous with regard to the use outdoors and in wet grounds, as said materials withstand such conditions without expensive post-processing being required because they do not corrode, for instance.

The invention also relates to a method for manufacturing an artificial turf barrier including a lawn barrier and a connecting grid, the lawn barrier and the connecting grid being formed by injection molding. The method according to the invention is characterized in that the artificial turf portion cut to size is placed into an injection mold and the lawn barrier and the connecting grid are non-detachably connected with the artificial turf portion during injection molding. As already mentioned such a method ensures that the artificial turf barrier according to the invention can be manufactured easily and quickly, simultaneously providing for a robust and durable connection between the artificial turf and the carrying structure.

It may be advantageous for the artificial turf portion to be cut to a circular ring shape. A correspondingly adapted artificial turf portion fits particularly well into round-shaped artificial turf barriers with a cut-out, e.g. for an irrigation nozzle.

In the following, it is occasionally also referred to carriers or artificial turf carriers. They substantially refer to the artificial turf barrier or components thereof that are not part of the artificial turf. In addition, the terms “connecting area” and “bonding area” are used synonymously throughout the entire application.

The invention relates to an artificial turf barrier and to a method for manufacturing the same as described above.

### BRIEF DESCRIPTION OF THE DRAWINGS

In the following, two advantageous embodiments of the invention will be explained with regard to drawings.

FIG. 1 is a top view of a round artificial turf barrier of the invention according to a first embodiment.

FIG. 2 is a sectional view of the artificial turf barrier of FIG. 1 along a cutting line B-B.

FIG. 3 is a top view of a straight artificial turf barrier of the invention according to a second embodiment.

FIG. 4 is a sectional view of the artificial turf barrier of FIG. 3 along a cutting line C-C.

FIG. 5 is a sectional view of the artificial turf barrier of FIG. 3 along a cutting line E-E.

### DETAILED DESCRIPTION

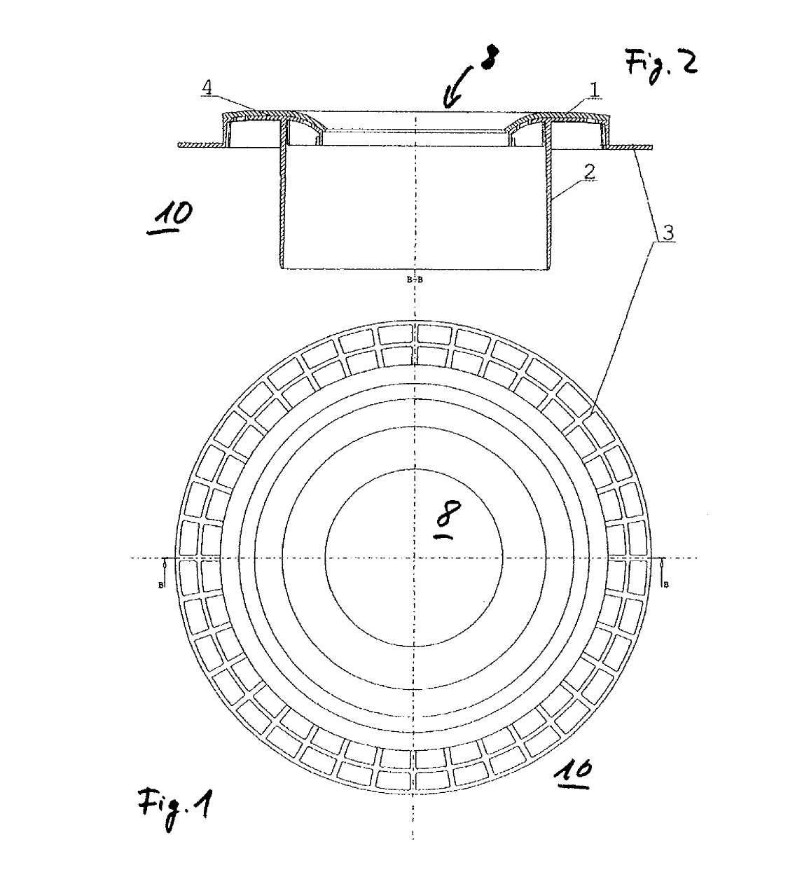

FIG. 1 is a top view of a first embodiment of an artificial turf barrier 10 according to the invention. As can sometimes be more apparent in FIG. 2, the artificial turf barrier 10 comprises artificial turf 1, a lawn barrier 2, a connecting grid 3, and a connecting area 4 for the artificial turf.

The artificial turf barrier 10 consists of a round growth barrier 2 which projects about 8 cm deep into the soil and also serves as a stabilizing element. The center thereof is provided with a round cut-out 8 (in the embodiment of a diameter of approx. 12 to 13 cm), to allow a nozzle of an irrigation system (not shown) to distribute water properly. As already mentioned, the artificial turf barrier may also be closed permanently or temporarily, e.g. by lids of flaps. Artificial turf 1 slopes towards the center by about 15 mm. Bonding area 4 has a diameter of about 25 to 30 cm, the horizontal connecting grid 3 is applied about 2 to 3 cm underneath the artificial turf bonding area 4 to enable the natural lawn to grow together with the artificial turf 1 at the same level. The grid projects about 4 to 5 cm. Positioned between inner cut-out 8 and connecting grid 3 is the artificial turf 1 which is to be combined with the remaining components by back injection molding. A thermoplastic synthetic material is intended for the artificial turf barrier 10. All dimensions are preferred, but may be changed, if required. It is preferred to have a round artificial turf area, however, if required it may also be manufactured in oval, star-shaped or in rectangular form.

The lawn barrier 2 inhibits growth of grass in a specific area. It prevents the roots of the adjacent lawn from advancing into the protected area. The lawn barrier is inserted into the soil about 8 cm deep, encloses the splash water element and prevents the roots from growing underneath the border. The wall is conically shaped with a tapered end so that it can be pushed into the soil easier. It also serves to stabilize the carrier.

The connecting grid 3 projects from the connecting area 4 by about 4 to 5 cm. It is positioned about 2 to 3 cm underneath the artificial turf connecting area 4 to allow the natural lawn to grow together with the artificial turf 1 at the same level so that no problems will arise while mowing the lawn. The connecting grid 3 is used to stabilize the construction which will be achieved as soon as the natural lawn has grown together with the connecting grid 3.

The artificial turf barrier 10 is made by injection molding. Artificial turf 1 cut to the form of a circular annulus is placed into an injection mold. The turf carrier including turf barrier 2 and connecting grid 3 is injection-molded and non-detachably connected with the artificial turf 1.

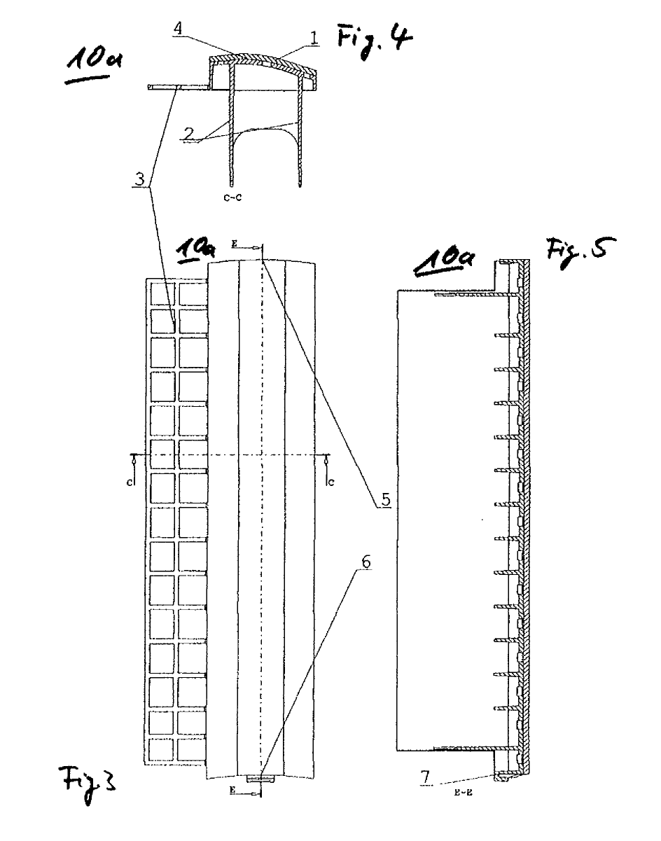

An embodiment shown in FIGS. 3 to 5 includes similar components fulfilling similar functions. In contrast to the first embodiment, this artificial turf barrier 10 is a straight turf edge 10a. However, it might also be a bent or a circular arc-shaped turf edge. Corner pieces are also conceivable. Artificial turf edge 10a prohibits the growth of grass etc. on paths, beds and areas bordering lawn. Preferably, it has an overall length of 34 cm and has a concave radius 6 formed on one of its ends and a convex radius 5 formed on the other end. One of its ends is provided with a hook 7 for combining individual elements, i.e. turf edges 10a, with each other without any seams. Artificial turf edge 10a includes a straight growth barrier 2 which projects about 8 cm deep into the soil and extends over the entire component, along with a stabilizing bar 2 extending parallel to said growth barrier at a distance of about 5 cm and projecting about 8 cm deep into the soil. The natural lawn side is provided with a connecting grid 3 which grows together with the natural lawn. The grid 3 has a width of about 4 to 5 cm and extends over the entire length. Artificial turf 1 is applied to the entire length of the component at a width of 7 cm by back injection molding. Artificial turf edge 10a is made of a thermoplastic synthetic material. Any kind of artificial turf 1 may be applied. All of the dimensions are preferred, they may, however, be changed upon need.

Turf edge 10a inhibits growth of weeds in a specific area. The plastic wall 2 prevents the roots of the adjoining lawn area from expanding into the protected area. Said wall projects about 8 cm deep into the soil and prevents the roots from growing and passing underneath the edge 10a. Wall 2 is conically shaped with a tapered end so that it can be pushed or inserted into the soil easier. It also serves to stabilize the carrier.

1. An artificial turf barrier, comprising: a lawn barrier, artificial turf, and a connecting area for said artificial turf, characterized by a connecting grid.

2. The artificial turf barrier according to claim 1, wherein it includes a round lawn barrier preferably projecting about 8 cm deep into the soil and thus serving to provide stability.

3. The artificial turf barrier according to claim 2, wherein a round or circular cut-out is provided in the center of the lawn barrier to enable a nozzle of an irrigation system to distribute water properly.

4. The artificial turf barrier according to claim 3, wherein the connecting area is provided between an edge of the connecting grid and the cut-out.

5. The artificial turf barrier according to claim 1, wherein the connecting grid is applied 2 to 3 cm lower than the connecting area.

6. The artificial turf barrier according to claim 1, wherein the connecting grid projects about 4 to 5 cm from the artificial turf.

7. The artificial turf barrier according to claim 1, wherein the artificial turf is connected to the connecting area by back injection molding.

8. The artificial turf barrier according to claim 1, wherein it includes a straight lawn barrier preferably projecting about 8 cm deep into the soil.

9. The artificial turf barrier according to claim 1, wherein a concave radius is provided on one end of the artificial turf barrier and a convex radius is provided on the other end.

10. The artificial turf barrier according to claim 8, wherein a hook is provided on one end thereof for combining adjacent artificial turf barriers with each other seamlessly.

11. The artificial turf barrier according to claim 8, wherein a stabilizing bar extends parallel to the lawn barrier at a distance of about 5 cm and projecting about 8 cm deep into the ground.

12. The artificial turf barrier according to claim 1, wherein the connecting grid is provided with a natural bottom side intended to grow together with the natural lawn.

13. The artificial turf barrier according to claim 8, wherein the artificial turf is applied to the entire length of the artificial turf barrier at a width of about 7 cm by back injection molding.

14. A method for manufacturing an artificial turf barrier including a lawn barrier and a connecting grid, the lawn barrier and the connecting grid being formed by injection molding, wherein an artificial turf portion cut to size is inserted into an injection mold and the lawn barrier and the connecting grid are non-detachably combined with the artificial turf portion during injection molding.

15. The method according to claim 14, wherein the artificial turf portion is cut to the form of a circular annulus.
